(19) United States
(12) Patent Application Publication
(10) Pub. No.: US 2010/0333152 A1
(43) Pub. Date: Dec. 30, 2010

(54) METHOD AND APPARATUS FOR CONTENT DISTRIBUTION TO AND PLAYOUT WITH A DIGITAL CINEMA SYSTEM

(76) Inventors: William Gibbens Redmann, Glendale, CA (US); James Paul Sabo, Pasadena, CA (US)

Correspondence Address: Robert D. Shedd, Patent Operations;THOMSON Licensing LLC, P.O. Box 5312, Princeton, NJ, 08543-5312, US

(21) Appl. No.: 12/450,213

(22) PCT Filed: Mar. 14, 2008
(86) PCT No.: PCT/US2008/003474

§ 371 Date: Sep. 16, 2009

Related U.S. Application Data
(60) Provisional application No. 60/920,648, filed on Mar. 29, 2007.

(51) Int. Cl. H04N 7/173; H04N 17/00

(52) U.S. Cl. 725/97; 348/180; 348/E17.001

(57) ABSTRACT

The present principles relate to a technique for distributing content destined to be played out on digital cinema systems. The content is preferably distributed compact, but non-digital-cinema-ready encodings. Upon receipt in the theatre, the content is transcoded as needed and played out on theatre systems. The system provides for miscellaneous pieces of content (separate picture and sound elements) to be automatically organized into a multimedia presentation along with other synchronized picture and sound content. The organization of this content may employ heuristics to optimize for revenue while considering aesthetics and showmanship.

### CROSS REFERENCE TO RELATED APPLICATIONS

This application claims the benefit of U.S. Provisional Patent application Ser. No. 60/920,648 filed on Mar. 29, 2007.

### BACKGROUND

1. Technical Field

The present principles relate to digital cinema systems. More particularly, they relate to a method and apparatus for content distribution to, and playout with, a digital cinema system.

2. Description of Related Art

Generally speaking, most movie theaters today show more than just movies. In a typical show sequence, early arriving audience members may take their seats as a sequence of still images, primarily comprising local advertising, are displayed over background music. As showtime approaches, many theatres switch to a canned 10-20 minute preshow containing advertising, but presented in an entertaining format, typically an entertainment reporting format. As showtime draws still closer, the ‘coming soon’ banner is displayed, followed by a sequence of teasers and trailers of upcoming features. The audience is advised that popcorn is available, to turn off their cell phones, and that the feature is about to start. At last, the feature begins.

In some theatres, the local advertising is literally a slide show, using a carousel projector and a source for background music. Some theatres arrange for a third party to provide an on-screen advertising (OSA) system, which supplies a dedicated projector and playback device, which is provided with ads, both local, regional, and national. These systems interact with the primary movie projector: either a film projector or a digital cinema system. The interaction is through an automation system, which minimally acts to ensure that the movie projector and on-screen advertising system do not simultaneously try to project on the screen.

Current OSA systems use high-compression encoding schemes, such as MPEG-4 (well known as the encoding used to manufacture DVDs). Digital cinema content such as trailers and features use specific encodings acceptable to studios, but these encodings schemes do not achieve compression ratios as high as that of MPEG-4, for example. Advantages of the encodings employed by OSA systems are that the higher compression ratio provides lower cost content distribution, faster content transfer times, and more efficient use of storage. These advantages usually outweigh the audience perception (if any) of producing a lower quality image and or sound.

Encodings such as MPEG-4 are sometimes referred to as ‘e-Cinema’, to be differentiated from those less-lossy, higher precision encodings accepted by the studios and known as ‘D-Cinema’.

It can thus be appreciated that there is a desire to make use of the digital cinema projector for both studio and advertising content. Most digital cinema projectors can accept images from more than one source, and switch between the two. Also, there are digital cinema screen servers available today which can decode and playout e-Cinema content and also D-Cinema content. Such screen servers utilize a single projector interface, but change output modes when switching between e-Cinema and D-Cinema content.

However, whether running from separate OSA and digital cinema screen servers and switching between projector inputs, or using a digital cinema screen server that plays both e- and D-Cinema content, there is a hiccough during the show at the transition from e-Cinema to D-Cinema content. That is, the differences in the image essence and signals provided to the projector are sufficient to require the projector to change configuration, resulting in many seconds of black screen. Often the image size (pixel count) is different. To remedy this, a lens move may be required, or engagement of an electronic image scaler may be needed. The color spaces in which e-Cinema and D-Cinema images are encoded are different, requiring the loading or calculation of separate color look-up tables. In addition, frame-rates may differ, possibly requiring a resynchronization of the projector's image pipeline.

Ideally, there would be no difference at the projector between advertising content and studio content, other than what the exhibitor, for showmanship reasons, chooses to impose (e.g., projector brightness). However, retaining the low distribution costs of more highly compressed content is valuable, and presently outweighs the inconvenience and disruption caused by switching formats within the projector, or the expense of having two projections systems dedicated respectively to e- and D-Cinema:

Another problem with both e-Cinema and D-Cinema content is that content for them is far more expensive to create and distribute than the historically used still image slides showing asynchronously over background music. The local pizza parlor merely wants to attract after-movie patrons, and a simple still image is sufficient to the task. However, creating and packaging an e-Cinema movie and soundtrack is what is required by the OSA system and it only gets more expensive when providing a D-Cinema package.

Presently, the most common practice is to provide a separate OSA playout server and its own projector. This represents a significant hardware, installation, and maintenance expense, and frequently requires the addition of an additional port (window) in the projection booth so the OSA projector can hit the screen. Thus, the theater or venue requires actual physical modification to accommodate this additional port

A few of the known OSA playout servers can be connected directly to the digital cinema projector. This requires careful intercommunication between and among the projector, OSA playout server, and the digital cinema screen server so that the projector is lit at the correct time, watching the appropriate one of two inputs, and the corresponding image source is playing, and the transition occurs at the appropriate time and the presentations are in sync. Audio must be effectively switched, too. In addition, the entire orchestration must account for the marginally-predictable projection switch-over timing.

Some digital cinema screen servers handle e-Cinema and D-Cinema content, but still face the projector switch-over timing which includes an undesirable blanking of the screen for several seconds.

Currently, the owner of the OSA is the only provider from which content can be accepted and presented with the OSA system. Today, Digital Cinema screen servers that support advertising are closed systems—that is all advertising must come through the provider of both the cinema and advertising equipment. It would be desirable for there to be a simple mechanism for providing simple ads for the “slide” portion of the presentation that promotes competition among advertising providers and equipment manufacturers, and allows exhibitors to select among a variety of entertainment content and advertising providers, or to develop their own content using popular, commercially available tools.

### SUMMARY

According to one implementation, the method for providing non D-cinema content for distribution and playback at theaters includes performing a quality control check on content master comprising non D-cinema content, the quality control check including, transcoding the non D-cinema content to produce D-cinema compliant content, transferring the D-cinema compliant content into a screen server, initiating playout and monitoring to ensure no unacceptable artifacts are present after transcoding, determining acceptability of the coded D-cinema compliant content, and duplicate/distribute the content master to a theater to be displayed when it has been determined to be acceptable.

The transcoding can be performed before or after the transfer of the content master to the screen server, and is performed according to policies to be encountered at an exhibition or displaying theater. The transcoding is substantially the same as or identical to the transcode used by an exhibition (auditorium/theater) facility.

According to one aspect, the non D-cinema content can be, for example, MPEG encoded content.

According to another implementation, the method for playing back non D-cinema content at an exhibition theater includes receiving a content master comprising the non D-cinema content at the exhibition theater, transcoding the non D-cinema content into a D-cinema compliant content form, transferring the content to a screen server, scheduling the playout of the D-cinema compliant content along with other content, and executing the playout schedule which includes both the D-cinema compliant content, and the other content. The scheduling can includes forming a show play list (SPL) having one or more composition playlist (CPL) such that the forming further includes modifying the SPL or internal one or more CPL to extend or shorten the SPL to accommodate preferences of the exhibition theater.

The modifying of the SPL or CPL can includes populating an SPL template from a point of sale (POS) system, lengthening the SPL or an internal CPL using rules in a rules database maintained by the exhibition theater, transferring the modified SPL to a screen server when the length of the SPL has been determined to be sufficient. The modifying can further includes monitoring and initiating playout of the SPL, determining, during playout, if the SPL is too long, shortening the SPL when it is determined to be too long, determining if the SPL length is sufficient when it is not too long, and lengthening the SPL when it is determined the length is not sufficient.

As mentioned above, the transcoding can be performed prior to or after the step of the transferring.

According to another implementation of the present principles, there is provided a computer program product comprising a computer usable medium having computer readable program code embodied thereon for use in communicating data over a communication channel, the computer program product having program code for receiving the non D-cinema content at the exhibition theater, program code for transcoding the non D-cinema content into a D-cinema compliant content form, program code for transferring the content to a screen server, program code for scheduling the playout of the D-cinema compliant content along with other content, and program code executing the playout schedule which includes both the D-cinema compliant content, and the other content.

In accordance with another implementation, the apparatus for playing back non D-cinema content at an exhibition theater includes a receiver for receiving the non D-cinema content, a processor configured to transcode the non D-cinema content into D-cinema compliant content, and a screen server configured to receive the D-cinema compliant content and deliver the same to a projector.

The screen server is further configured to schedule the playout of the D-cinema compliant content along with other content, and to execute a playout schedule including both the D-cinema compliant content and the other content.

According to one aspect, the transcoded D-cinema compliant content delivered to the projector is substantially similar to post-transcoded D-cinema content previously reviewed at a distribution side of the content.

The playout schedule can include a show play list (SPL) having one or more composition play list (CPL), where the processor and screen server cooperate to modify the SPL or the one or more CPL to extend or shorten the SPL to accommodate preferences of an exhibition theater. The preferences of the exhibition theater can be maintained in a rule database stored in a storage medium that is in communication with the processor. The rule database can be local to the exhibition theater, or can be remotely located from the same.

According to a further implementation, the apparatus for playing back non D-cinema content at an exhibition theater includes a receiver for receiving the non D-cinema content, a screen server configured to receive the non D-cinema content, and a processor configured to transcode the non D-cinema content into D-cinema compliant content after being received by the screen server, where the screen server delivers the D-cinema compliant content to a projector. According to one aspect, the transcoded D-cinema compliant content delivered to the projector is substantially similar to post-transcoded D-cinema content previously reviewed at a distribution side of the content.

The details of one or more implementations are set forth in the accompanying drawings and the description below. Even if described in one particular manner, it should be clear that implementations may be configured or embodied in various manners. For example, an implementation may be performed as a method, or embodied as an apparatus configured to perform a set of operations or an apparatus storing instructions for performing a set of operations. Other aspects and features will become apparent from the following detailed description considered in conjunction with the accompanying drawings and the claims.

### BRIEF DESCRIPTION OF THE DRAWINGS

In the drawings wherein like reference numerals denote similar components throughout the views:

FIG. 1 is diagrammatic view of a variety of content that can be used by the present principles;

FIG. 2 is diagrammatic representation of various timelines corresponding to the content shown in FIG. 1;

FIG. 3 is a diagrammatic representation of different timelines having shorter intervals than those of FIG. 2;

FIG. 4 is a diagrammatic representation of a plurality of transcode operations that support the present principles;

FIG. 5 is block diagram of a content distribution system according to an implementation of the present principles;

FIG. 6a is a flow diagram of a pre-distribution quality control check according to an implementation of the present principles;

FIG. 6b is a flow diagram of and ingest, transcode and playout process according to an implementation of the present principles;

FIG. 7 is table representation of a content database, a decrease rule database and an increase rule database; and

FIG. 8 is a flow diagram of the timeline editing process according to an implementation of the present principles.

### DETAILED DESCRIPTION

The present principles provide a way for e-Cinema content to be distributed to theatres, transcoded to look and behave like D-Cinema content, so that it may be seamlessly displayed using D-Cinema screen servers, thus providing a presentation exhibiting improved degree of showmanship, but providing a lower cost of distribution.

The system and methods not only provide the benefits of the more efficient encoding schemes, but further reduces the costs of producing and distributing simple ads by separating still images and silent video from background audio, and allowing them to be composed into an audio/visual presentation at or near the time of presentation.

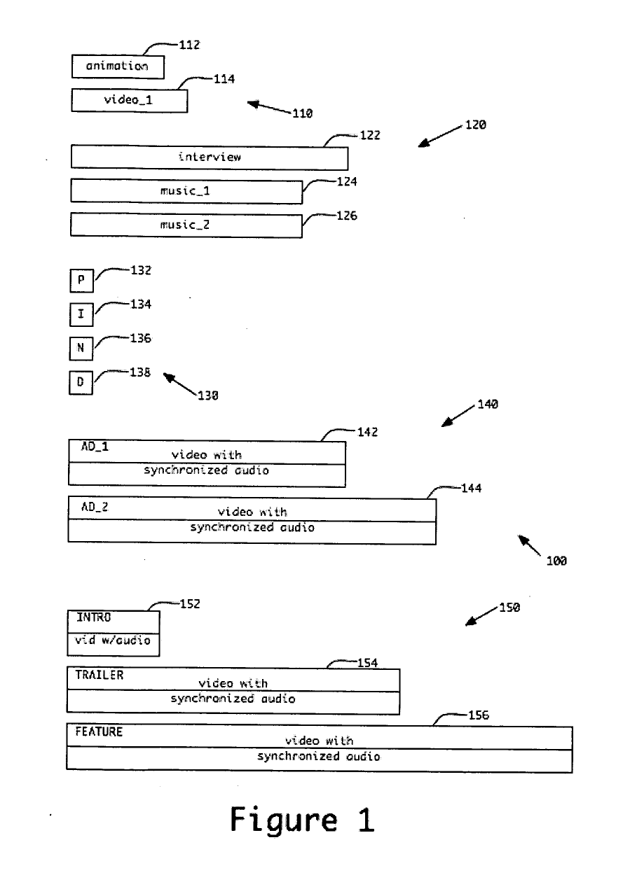

Referring to FIG. 1, a variety of content usable by the present principles is shown, including non-D-Cinema content 100 comprising silent video clips 110, audio tracks 120, still images 130, and e-Cinema content 140; and standard D-Cinema content 150.

Silent video content 110 can be an animation 112 (the content of which is designated herein as ‘animation’ or abbreviated as ‘ani’), provided in a presentation language such as PowerPoint™ by Microsoft Corporation, of Redmond, Wash. or Flash™ by Adobe, Inc. of San Jose, Calif. It can also be provided in a regular digitized video format, such as DV, AVI, or an MPEG-4 encoded file, as is video file 114 (the content of which is designated herein as ‘video_1’).

Audio tracks 120 are preferably provided without a pre-associated image component. Generally, this will be background music or other free running audio not requiring a synchronized image. Examples of audio tracks 120 include interview WAV file 122 (the content of which is designated herein as ‘interview’), a first music WAV file 124 (the content of which is designated herein as ‘music_1’) and a second music MP3 file 126 (the content of which is designated herein as ‘music_2’).

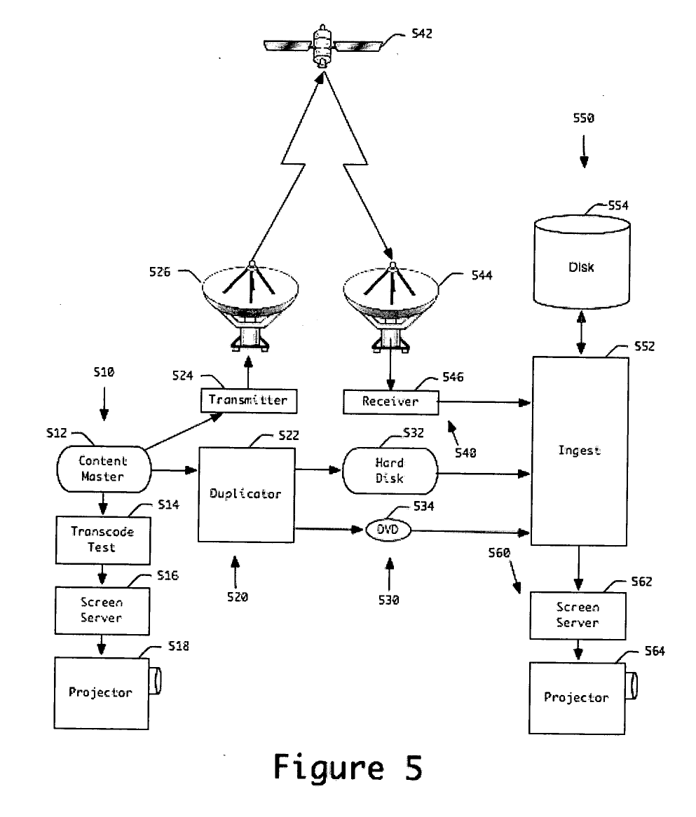

In addition, automation cues (not shown) may be employed to cause the audio system (not shown) of the auditorium (560 in FIG. 5) to switch to a distinct source of background audio (e.g., a theatre-wide background music channel, not shown) for intervals in timeline 200 where no audio content is specified (none shown). When the timeline 200 again specifies audio file content, automation cues are provided to cause the audio system of the auditorium to switch back to using the screen server (562 in FIG. 5) as the source of audio for the auditorium. Preferably, the switching of the audio channel includes a brief, momentary gain fade to prevent an audio ‘pop’ from being heard in the auditorium.

Still image files 130 are exemplified by pizza parlor ad in PNG file 132 (the content of which is designated herein as ‘P’), an ice cream parlor ad in TIFF file 134 (the content of which is designated herein as ‘I’), a subscription offer for the local newspaper in JPG file 136 (the content of which is designated herein as ‘N’), and a drain cleaning service ad in JPEG2000 file 138 (the content of which is designated herein as ‘D’).

The actual variety of image formats in which still image might be delivered to a theatre is preferably constrained. However, this is more for operational ease and not due to technical limitations. As will be shown below, because of quality control processes and the value of having source materials with strongly characterized or prescribed properties, it is preferable to provide very few formats in each category.

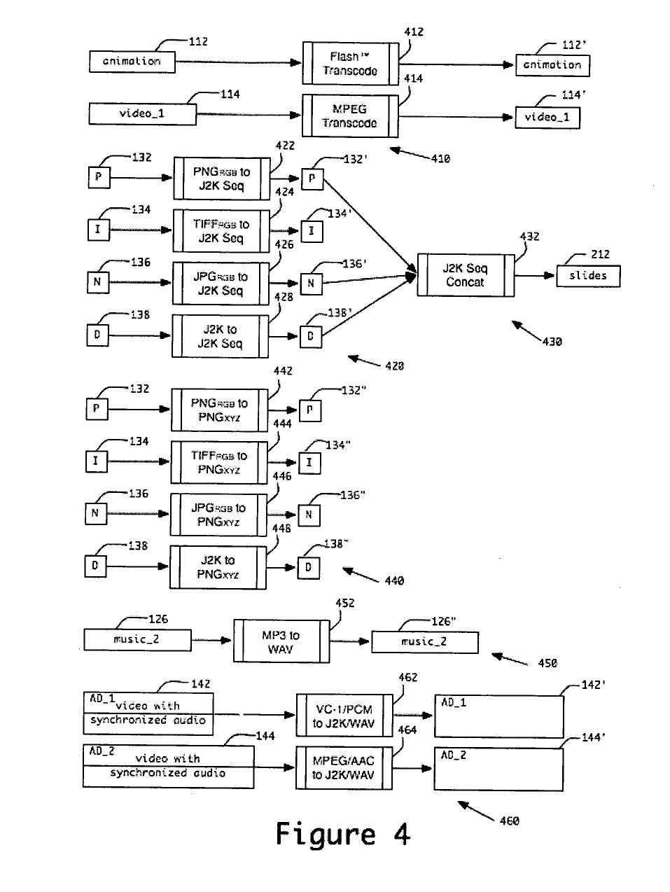

In Digital Cinema, images are required to be in the X′Y′Z′ color space (discussed below in conjunction with FIG. 4), which is substantially different than the RGB color space used in the vast majority of multimedia software (and in all the file formats mentioned above). Still images 130 could be provided in a JPEG2000_{X′Y′Z′} or PNG_{X′Y′Z′} file, which would simplify the processing described below. However, that forgoes two advantages of providing still images 130 in widely used formats: First, the ease of creating and editing images with well known, widely available, low-cost workstations and software tools; and second, the ease of providing the advertiser and exhibitor a way of previewing the finished ad by simply calling up the file on a general purpose PC. While such a review station (not shown) would not have all the color calibration and other settings appropriate to content mastering station (not shown), it is sufficient for an advertiser or exhibitor to check the ad for accuracy, suitability and workmanship.

Typical e-Cinema content 140 can include high definition (HD) content using, for instance, a VC-1 video encoding and a PCM audio encoding as in HD file 142 (the content of which is designated herein as ‘AD_1’) or other encodings as might be found in an HD DVD or Blue-Ray™ high definition digital video disk. Similarly, and at much lower costs of production, content may be provided in standard definition (SD), for example SD file 144 (the content of which is designated herein as ‘AD_2’) using, in this instance, MPEG-4 as the encoding for video and AAC encoding for audio as commonly found in popular DVDs.

In the following discussion, standard Digital Cinema content 150 includes a short “And Now, Our Feature Presentation” file 152 introducing the feature (the content of which is designated herein as ‘INTRO’), a studio provided trailer file 154 (‘TRAILER’), and the feature file 156 (‘FEATURE’).

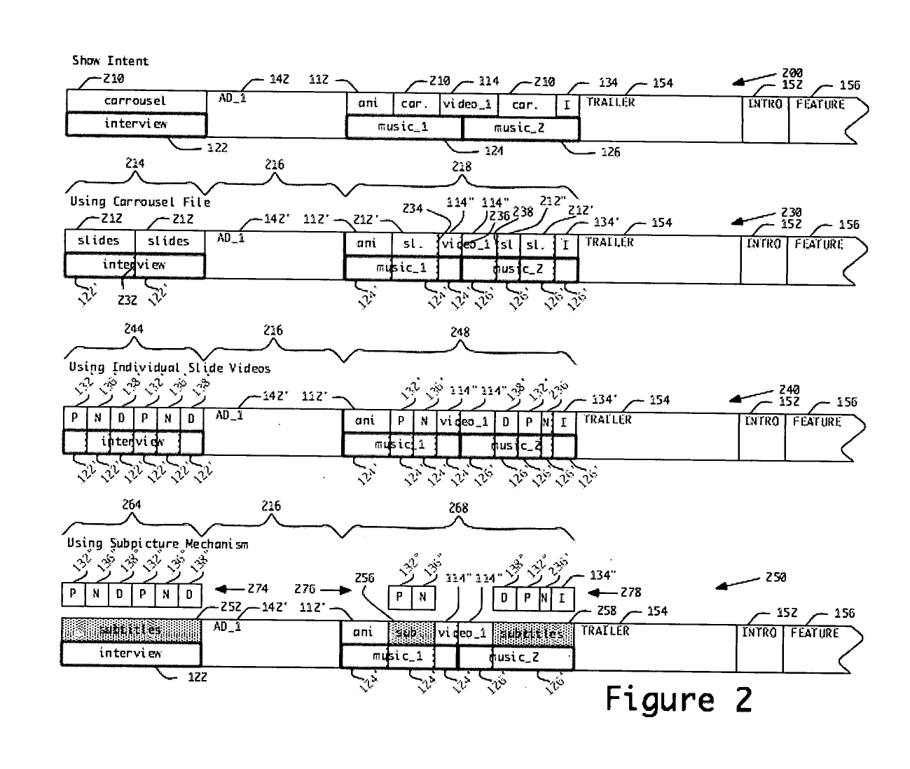

With reference to FIG. 2, an ideal show timeline 200 is shown, which makes use of the assets provided in FIG. 1. An editor is responsible for constructing timeline 200. This editor may be the theatre projectionist, the theatre manager, or other personnel. Preferably, a template (not shown) is provided as the basis for timeline 200, so that repetitious manipulations and checks (e.g., always placing INTRO 152 immediately before FEATURE 156; ensuring that all trailers proceed INTRO 152, etc.) are less burdensome.

A template may be unique to a theatre, an auditorium, or kind of performance (e.g., children's matinee vs. late night double-feature picture show), or combinations thereof. Such templates and timelines also preferably include automation cues (not shown), for example to operate curtains or dim the lights at appropriate times in coordination with the presentation.

Alternatively, the creation of timeline 200 may be automated, in which case the editor is an algorithm. Note, that it is not necessarily the case that all available content 100 is used, for instance the ‘AD_2’ file 144 is not used in timeline 200.

When dealing with the still image ads, an editor can specify which slides play in which order, for how long, and with what accompanying audio. However, for the convenience of the editor, a collection of still images (in this example consisting of images 132, 136, and 138) is referred to collectively as the carousel 210 (also abbreviated as ‘car.’). The carousel 210 behaves much like a classic carousel slide projector, that is, wherever the carousel 210 is placed in timeline 200, the intent is to display a still image. The still image being displayed is the least-recently-displayed member of the carousel 210 collection, and each still image is displayed for about the same amount time, in succession, as often as necessary to fill the assigned span in timeline 200. More elaborate implementations are contemplated as being within the scope of this disclosure, such as allowing different images to be displayed for different or adaptive amounts of time, depending upon the editor's selection, complexity, advertising fees paid, comment metadata within the source still image file, how much time is available (i.e., how much time until a non-carousel image source is to be used), etc.

Further, it is desirable for the behavior of carousel 210 to avoid displaying any image for a very short period, for example, if in a carousel sequence each still image is shown for five seconds, and the time remaining in the duration of a carousel would only leave one second for the next still image, it would be ideal for the prior image to be held for six seconds and forgo, for the time being, showing the next still image. Alternatively, the carousel 210 behavior may include stretching each of the four prior still images displayed by a quarter second, rather than the last one being stretched by a full second.

Idealized timeline 200 specifies that the show begins with audio ‘interview’ 122 while the images of carousel 210 are repeatedly displayed. In this example, the three still images in carousel 210 sequence exactly twice during the single playout of ‘interview’ 122.

In addition, automation cues (not shown) may be employed to cause the audio system (not shown) of the auditorium (560 in FIG. 5) to switch to a distinct source of background audio (e.g., a theatre-wide background music channel, not shown) for intervals in timeline 200 where no audio content is specified (none shown). When the timeline 200 again specifies audio file content, automation cues are provided to cause the audio system of the auditorium to switch back to using the screen server (562 in FIG. 5) as the source of audio for the auditorium. In one implementation, the switching of the audio channel includes a brief, momentary gain fade to prevent an audio ‘pop’ from being heard in the auditorium.

Next in timeline 200 is AD_1 142′, which provides its own synchronized audio and video. AD_1 142′ is followed by two selections of music, music_1 124 and music_2 126″ (derived from MP3 file 126, as discussed below). While these music selections play, animation 112′ is shown, followed by a resumption of carousel 210, followed by video_1 114′, followed by still more of carousel 210, followed finally by some seconds of ice cream parlor ad ‘I’ 134′, which ends in conjunction with the end of the playout of music_2 126″.

At this point in the timeline 200, TRAILER 154 is shown with its synchronized audio, followed by INTRO 152, and finally what the audience paid to see, FEATURE 156 (only the first portion shown in FIG. 2).

Note that having the editor identify times when the carousel 210 is to play is a valuable shorthand, as opposed to having to specify individual still images, which can still be done as with ice cream ad 134′. Alternatively, if the editor were to specify only the non-carousel image portions (e.g. animation 112 and video_1 114), placement of carousel 210 could be presumed as the default for any interval not otherwise containing image content.

In an analogous construction, a collection (not shown) of background audio could be identified. Wherever image content having no audio portion (e.g., animation 112, video_1 114, still images 132, 134, 136, and 138) is specified, the next portion of the collection of background audio is played in conjunction. Preferably, transitions to and from audio in this collection are made on boundaries between members of the collection. For example, if the collection were comprised of interview 122, music_1 124, and music_2 126, then a transition to or from the collection would preferably occur at the beginning of interview 122, between interview 122 and music_1 124, between music_1 124 and music_2 126, or at the end of music_2 126. Transitions to or from within an audio track are preferably avoided, but if used, they can include automation commands or screen server behaviors (e.g. a fade) to prevent an audio pop from a discontinuity in the audio stream.

In order for a Digital Cinema screen server to produce the performance anticipated by show intent timeline 200, the intent must be represented by a show playlist (SPL) which calls for a sequence of one or more composition playlists (CPL). The nature of the CPL is an XML file as described in SMPTE Standard 429-7 Composition Playlist, and while standards for the SPL are still in development, as of today all manufacturers of digital cinema screen servers provide software which can create, store, load, edit, and playout a show playlist referencing CPLs, though with the SPL storage format for each being in their own proprietary, non-transportable format.

In Digital Cinema, a CPL is a synchronized presentation of picture and audio, and optionally includes subtitles synchronized elements (e.g., automation). FEATURE 156 is defined in a single CPL, as are TRAILER 154 and INTRO 152. When the HD file 142 for AD_1 is converted for digital cinema use under the present principles, the result is AD_1 file 142′, comprising a CPL 216 and additional asset files described below in conjunction with FIG. 4.

Normally, a CPL is provided by a studio or by a digital cinema packaging service retained by a studio. The decisions made regarding the selection and synchronization picture and audio is part of the motion picture post-production pipeline. Here, as when making traditional movie prints, image and soundtrack essence have a 1:1 correspondence: the twenty minutes or so of picture that corresponds to a reel of film has a corresponding soundtrack that is exactly the same duration. If subtitles are included, then those subtitles are contained entirely within that interval.

However, the present principles anticipate that image-only or sound-only files do not necessarily have a 1:1 correspondence within a CPL as picture and sound AD_1 file 142′, and in fact, they are likely not to.

Three implementation alternatives for the carousel and additional still image behaviors are provided for exemplary purposes. These may co-exist in a single implementation, but are shown distinctly herein. Each still image file 132, 134, 136, 138 is processed by at least one of the following methods, so as to be displayed for an interval of time determined by the editor's prescription when played on the digital cinema screen server.

Each still image is preferably converted into a PNG_{X′Y′Z′} format suitable for use with the well-known digital cinema “subpicture” subtitle mechanism, as employed in SPL 250.

Alternatively, each of the still images files is converted into a digital cinema JPEG2000_{X′Y′Z′} encoding and replicated 24 times for each second of desired playout and collected in a digital cinema track file, represented as corresponding files 132′, 134′, 136′, and 138′, and employed in SPL 240 (with 134′ also being employed in SPL 230). In still another implementation, a slide file 212 representing carousel 210 may be constructed (the content of which is designated herein as the ‘slides’ and abbreviated as ‘sl’), consisting of the concatenation of the collectively referenced sequence still images, which in this example are the pizza parlor, newspaper, and drain service ads (‘P’, ‘N’, and ‘D’). Such a slide file 212 is used in SPL 230.

For a carousel-file-based implementation as referenced by SPL 230, a CPL 214 must be created that defines the composition of the slides file 212 for images and interview file 122 for audio. In a CPL, in order to playout an audio track in precisely defined synchronization with an image sequence, the audio and the image sequence must be exactly the same duration. The first portion of SPL 230 consists of a CPL 214 having two reels (an internal construct of CPLs well known to practitioners in the field). Reels, too, require audio and image sequences having exactly the same duration, and are provided with the additional assurance that consecutive reels within a CPL will be played out without any discontinuity in the image or audio presentation. The first reel of CPL 214 specifies the entirety of slides file 212 and a first consecutive piece 122′ of interview file 122. The first reel ends with the end of the first slides file 212 and at the first portion 122′ of interview 122 at artificial boundary 232, which is simultaneous. The second reel of CPL 214 identifies the slides file 212 again, the audience will see the carousel images repeat, and the second consecutive portion 122′ of interview 122. The audience will hear no discontinuity in the playout of the two audio portions 122′ of interview file 122.

That interview file 122 is exactly twice the length of slides file 212 may be viewed as a coincidence in this example, or it may be considered that there was a forward looking decision made in the construction of slides file 212 and that the selection of precisely how many replicated frames of each of still images 132, 136, and 138 were assembled was informed by the length of interview file 122.

Note, that it is currently a requirement that a CPL identify audio in integer increments (called ‘edit units’) of, typically, exactly 1/24th of a second. In the case that the necessary portion of an audio track like interview file 122 does not represent an exact multiple of that value, the end of the audio track can be padded with silence (not shown), or the audio can be scaled by techniques known in the art. Note that the latter is generally not considered an aesthetic technique when applied to music, due to quality issues in the scaling and the pitch error which may be detectable to those in the audience having perfect pitch.

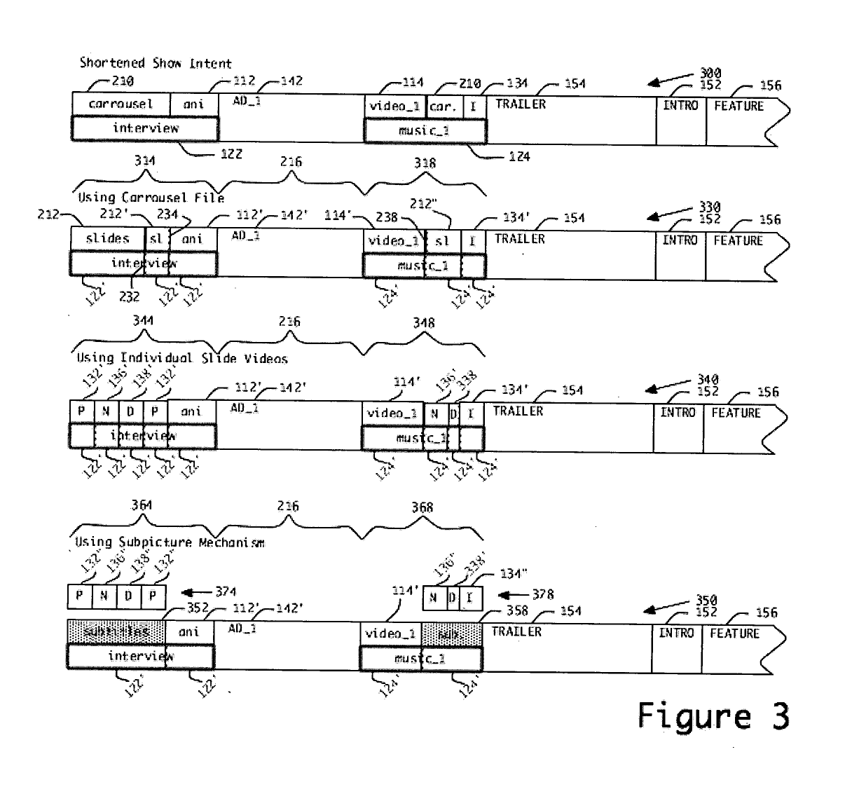

Once the interview 122 and two iterations of the slides file 212 have been played, SPL 230 references CPL 216 so that AD_1 142′ is played. Note that the CPL 216 is used throughout FIGS. 2 and 3 in all SPLs, for all instances of AD_1 file 142′.

Subsequently, SPL 230 references CPL 218. Compared to earlier CPLs 214 and 216, CPL 218 is complex, as many assets of differing lengths are composited to make a continuous, synchronous performance. The audio is taken from music_1 124 and music_2 126. Images are provided by animation file 112′, video_1 file 114′, and ice cream ad file 134′, each separated from each other by varying amounts of slides file 212. The resulting CPL 218 has seven reels with five artificial boundaries like 232 in the audio, and one artificial boundary 236 in the midst of video_1 file 114′. Note, that for clarity and because of the frequency with which artificial boundaries 232 occur in the audio tracks of FIGS. 2 and 3, and artificial boundaries 234 occurs within the image tracks in FIG. 2, only the two instances 232 and 236 are explicitly numbered, however all are indicated by the boundaries marked with hash-marks.

CPL 218, begins with a first reel composed of animation file 112′ and a like-duration first portion 124′ of music_1 file 124. The duration of this first reel is defined by the actual duration of animation file 112′, and an artificial boundary like 232 marks the break in the composited audio file, music_1 124, which does not have an intrinsic break at this point.

A second reel in CPL 218 is composed of a first portion 212′ of slides file 212 and the next consecutive portion 124′ of music_1 file 124, this consecutive portion of 124′ selected to have a duration matching that of the first portion 212′. In this case, there is no intrinsic duration of either the video or audio selections which drives the choice of the duration for this second reel. Rather, the duration is driven by a decision made in the editing to only show two slides of the carousel to separate the two silent video files 112′ and 114′. Artificial terminator 234 (and others like-marked elsewhere) indicates that slides 212′ is not a complete playout of slides file 212 before the switch to video_1 file 114. It is likely to be a frequently used property of the slides file 212 that the selection of duration will be directed at individual still image sequence within the slides file 212, rather than at the duration of one or more integer repetitions of the entire file 212 as illustrated in conjunction with interview file 122.

The third reel of CPL 218 includes a first portion 114″ of video_1 file 114′, and the next consecutive portion 124′ of music_1 file 124. This third reel ends with the end of music_1 file 124, and an artificial boundary 236 in video_1 file 114′.

A fourth reel is composed of the latter portion 114″ of video file 114′ and the first portion 126′ of music_2 file 126″.

A fifth reel is composed of a last portion 212″ of slides file 212 and the next portion 126′ of music_2 file 126″. Preferably, this last portion 212″ of slides file 212 begins on a boundary between two still images such that the still image that begins this portion 212″ is displayed for a duration typical of the other slides in file 212.

A sixth reel is the first portion 212′ of the fourth repetition of slides file 212 and the next portion 126′ of music_2 file 126.

The final, seventh reel in CPL 218 is composed of ice cream parlor ad file 134′ composited with a last portion 126′ of music_2 file 126″. The duration of the sixth reel is determined by the editor to cause ice cream ad 134′ to have an appropriate duration and be synchronized with the end of music_2 file 126″. In this example, it is not the case that there is a neat alignment in slides file 212, and one of the still images may be shorter than others. While this may be moderated by the editor for aesthetic purposes, it is only technically a problem if a reel is designated to be less than one second long, which is the minimum allowable reel length according to current standards.

The remainder of the SPL 230 is composed of the three CPLs calling out standard D-Cinema content 150, namely, INTRO 152, TRAILER 154, and FEATURE 156, each of which reference provided audio and image track files in standard D-Cinema formats.

The same presentation can be achieved by allowing each still frame to be called out separately, as shown in SPL 240 and its unique CPLs 244 and 248. The three slide files “P” 132′, “N” 136′, and “D” 138′ are cyclically selected wherever carousel 210 is specified in ideal timeline 200. The result is that CPL 244 will have six reels (as opposed to the two in corresponding CPL 214) and CPL 218 will have nine reels (as opposed to seven in corresponding CPL 218). The complexity implied by the increased reel count may be at least partially offset by not having to re-construct slides file 212 every time a still image is added to or removed from the carousel group.

Each of the six reels making up CPL 244 include a portion of interview file 122 and the entirety of one of the three slide files 132′, 136′, and 138′. In CPL 218, the first, second, third, sixth, seventh, and ninth reels comprise the entirety of animation file 112′, “P” 132′, “N” 136′, “D” 138′, “P” 132′, and “I” 134′, respectively, The fourth and fifth reel comprise the first and second portions 114″ of video_1 114′, and the eighth reel comprises a portion 236 of “N” 136′.

Compared to the implementation represented SPL 240, one advantage to embodying carousel 210 as in SPL 230 as slides file 212 derived from the still images is that the transitions between slides can be calculated and recorded in slides file 212, for example, the first several and last several replicated frames of ad still image “p” 132 can embody a fade from black to the still image and back, respectively. Alternatively, the first several frames can embody a crossfade from the prior still image in the carousel cycle. These more pleasant transitions between still images can require more judicious entry to and exit from the slides file 212, however the aesthetic value of the carousel sequence is greatly improved.

In still another implementation, the same presentation can be achieved using the subtitle mechanism specified for Digital-Cinema, as shown in SPL 250. This implementation is attractive due to the low storage requirements for still image ads and the ease of generating the aesthetic improvements of crossfades and fades to and from black.

In SPL 250, CPLs 264 and 268 both reference the same audio tracks as in corresponding CPLs 214 and 244 in SPL 230 and CPLs 218 and 248 in SPL 240. Individual reels in CPL 268 reference animation 112′ and first and second portions 114″ of video_1 114. CPLs 264 and 268 make use of the subtitle mechanism of Digital Cinema by referencing subtitle track files 274, 276, and 278. The MainSubtitle reference 252 to subtitle track file 274 occurs in reel one of CPL 264. MainSubtitle reference 256 to subtitle track file 276 occurs in reel two of CPL 268, and MainSubtitle reference 258 to subtitle track file 278 occurs in reel five of the same CPL. Each of still images 132, 134, 136, and 138 are converted into the PNG_{X′Y′Z′} format appropriate producing subpictures 132″, 134″, 136″, and 138″ which can be referenced subtitle track files. Preferably, each subpicture reference in a subtitle track file includes a FadeUpTime and FadeDownTime that aesthetically transitions into and out of a still image, which may optionally include a crossfade. There may be further finesse applied to the fade specifications on, for example the first or last slide in a sequence. In particular, a longer fade out immediately prior to TRAILER 154 is shown in the example subtitle track file 278.

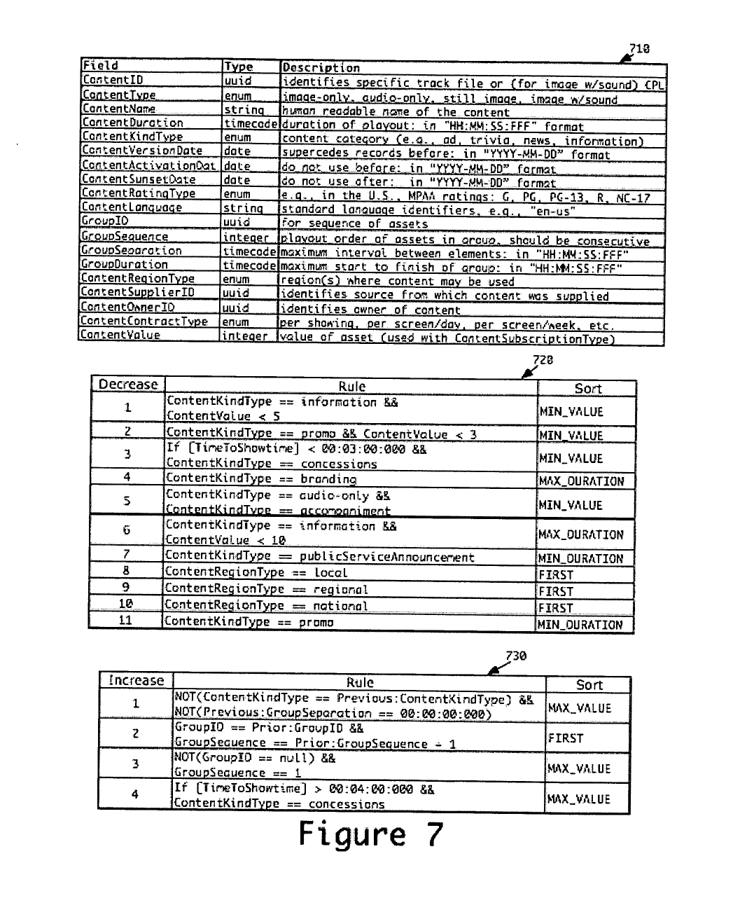

Referring to FIG. 3, similar mechanisms are used for each of three SPLs 330, 340 and 350 implementing the intended presentation of timeline 300. Timeline 300 specifies a presentation having a shorter interval between the time the show starts and the time the feature starts. If timeline 200 and 300 can be generated ahead of time by an editor, or generated by just-in-time automatic means as discussed below in conjunction with FIG. 7, then a selection of which timeline is appropriate may be made approaching or during the show based on a external selection by a projectionist or theatre manager. For instance, a shorter preshow (fewer ads) might be the normal mode, but in case of foul weather delaying the arrival of substantial portions of an audience or uncommonly long concession lines, an exhibitor may decide to delay the start of the feature by a few extra minutes, without going to a dead screen as hitting ‘pause’ on the server might.

In shortened timeline 300, music_2 126 (shown in FIG. 2) has been eliminated to trim down the duration of the preshow. As a result, animation 112 has been moved ahead of AD_1, and fewer runs through the carousel (presumed in this example to be the lowest revenue impact for the exhibitors). First CPLs 314, 344, and 362 corresponding to alternative implementation SPLs 330, 340, and 350 employ the resources and methods identified in conjunction with FIG. 2, though subtitle track file 374 is referenced by MainSubtitle reference 352 in SPL 350. Similarly, Third CPLs 318, 348, and 368 replaced their longer counterparts in FIG. 2. Again in SPL 350, a new subtitle track file 378 is called out by MainSubtitle reference 358.

Those of ordinary skill will recognize that the principles demonstrated in SPLs 230, 240, and 250 can be used consistently throughout an SPL, or they can be mixed and matched. Similarly, the creation of specific subtitle track files, such as 274, 276, 278 and their counterparts in SPL 350 could be mixed with the mechanism of slides 212. In such a case, first CPLs 264 and 364 would each gain an additional reel, as a common subtitle track file (not shown) of the same example duration as slides 212 would include only references to subpictures 132″, 136″, and 138″ would be used wherever carousel 210 is called for in the corresponding timeline (200 or 300). Such a mechanism would generate a reel count in the affected CPLs identical to those in corresponding carousel-based CPLs 214, 314, 218, and 318. Thus, the present invention contemplates that many implementation choices are available.

Further, CPLs and the associated content files, or amalgamations thereof (whether a simple collection of unrelated compositions, or a hierarchical collection that includes sequencing information), might be provided to an exhibitor or distributor by third parties for inclusion in presentations.

FIG. 4 shows a number of transcode operations that support the present principles. The specific transcode operations described are merely exemplary and not intended to limit the selection of file formats available for display by exhibitors.

Video transcoding 410 of video-only content supplied in any of a great variety of forms results in the same content, but in D-Cinema format. Two examples used herein are animation 112 and video_1 114.

Animation 112 can be provided in an animation programming language, for example as a .swf file produced in Flash™ by Adobe, Inc. of San Jose, Calif. Transcoder 412 would execute the Flash™ animation 112 and individual image frames would be captured and translated from RGB color (a color space commonly used in computer graphics) and converted according to X′Y′Z′ color. Further, each resulting frame is concatenated to product animation 112′ suitable for direct reference in CPLs. If necessary, individual frames are scaled, or cropped, or provided with a border, to achieve a final image of an appropriate size, as needed.

Similarly, MPEG video sequence video_1 114 can be converted by transcoder 414 by rendering each frame of the MPEG sequence (starting with a keyframe, know to those familiar with MPEG as an I-frame) and performing the translation from the MPEG YCrCb color space to X′Y′Z′.

Transcoders 412 and 414 may perform frame rate conversion as needed to match the frame rate of the target SPL, and ensure that the resulting files are integer multiples of the target frame rate and padding with black or the last image as needed, according to policy.

In one implementation, all non-D-Cinema image content is provided with a white point and color gamut that is uniform or otherwise standardized, so that each image transcoder in FIG. 4 can utilize a pre-determined transform from the source color encoding to the target X′Y′Z′ color encoding preferred by D-Cinema. Alternatively, metadata provided in or with each source image can describe the source color encoding (for instance, the white point, the gamma, the primaries, etc.) and the translation can be made by applying such metadata to equations known in the art.

Still image transcoding 420 converts still images into D-Cinema image track files.

Transcoder 422 converts Pizza Parlor ad “P” 132 supplied in PNG_{RGB} format from the PNG encoding in RGB color space into X′Y′Z′ color space encoded with JPEG2000 (abbreviated as J2K) to comply with D-Cinema image standards and then replicates that image twenty-four times for each second of duration, storing the result as “P” 132′, a D-Cinema image track file.

Similarly transcoder 424 converts Ice Cream ad “I” 134 supplied in TIFF_{RGB} format into the J2K_{X′Y′Z′} format and replicates the result to create D-Cinema image track file “I” 134′. Transcoder 426 converts Newspaper ad “N” 136 from JPG_{RGB} format into the J2K_{X′Y′Z′} format and replicates the result to create D-Cinema image track file “N” 136′.

If desired for aesthetic reasons, transcoders and replicators 422, 424, 426, and 428 may include a fade in and fade out of the frames at the beginning and end of each file 132′, 134′, 136′, and 138′, according to a predetermined policy.

When presented with Drain ad “D” 138 already in X′Y′Z′ color space and D-Cinema JPEG2000 encoding, processor 428 merely needs to replicate the image and package the result as D-Cinema image track file “D” 138′.

Carousel creation 430 incorporates both the still image transcode, replication, and packaging 420, except that concatenation process 432 combines the multiple replicated images 132′, 136′, and 138′ into slides file 212, also a D-Cinema image track file. Still image “I” 134 is not in carousel 210, and thus is not included in slides 212.

Subpicture preparation 440 takes the same source materials 132, 134, 136, and 138, but transcoders 442, 444, 446, and 448 convert from the source encoding and color space and produce corresponding PNG encoded files 132″, 134″, 136″, and 138″ in X′Y′Z′ color space.

Audio transcoding 450 provides source audio music_2 126 to transcoder 452 which decodes from MP3 or other audio format and encodes as D-Cinema compliant audio track file music_2 126″ having the audio is encoded in WAV format in chunks, typically, of 1/24th second. Since the D-Cinema requirement is that audio files are integer multiples of the frame rate in duration, the first or final 1/24th of a second may be padded with silence. Audio transcoding 450 may also provide a fade to/from silence over a brief interval at either end of the file, to assure that no audio pops occur, or that an aesthetic transition effect is provided, according to a predetermined policy.

Audio/visual transcoding 460 accepts files having synchronized audio such as high definition digital file AD_1 142 and MPEG4 DVD file AD_2 144. They are handled by transcoders 462 and 464 respectively, each providing appropriate video and audio conversions as above to produce the corresponding image and audio track files 142′ and 144′ respectively and the corresponding CPL that references and synchronizes the image and audio. As AD_2 is not used in timelines 200 and 300, only CPL 216 corresponding to the audio and image track files 142′ is shown.

Referring now to FIG. 5, mastering 510 feeds distribution, which may comprise duplication 520 and shipping of transportable media 530, or telecommunications 540, to an exhibition theatre 550 including auditorium 560.

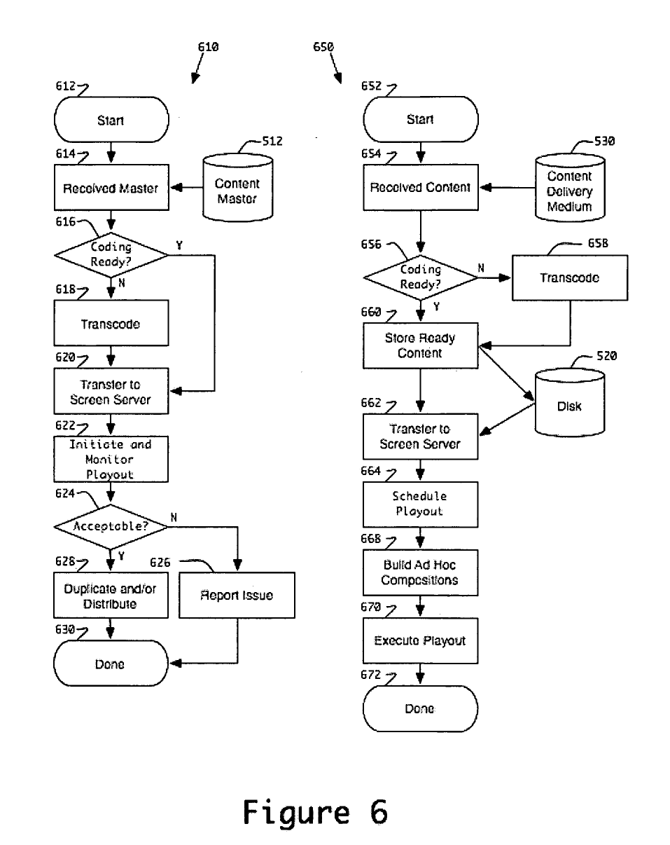

In mastering 510, a content master 512 is created or provided. Preferably before distribution, a quality control check 610 (see FIG. 6) is run. Content master 512 may comprise any of the moving image, still image, audio, or synchronized image and audio content previously discussed. The quality control check 610 begins 612 and content master 512 is received 614 (or created) in mastering 510. If content master 512 is found at 616 to require transcoding, it is submitted 618 to transcoder 514. Transcoder 514 preferably includes any transcoding, replicating, and packaging process discussed in conjunction with FIG. 4 and appropriate to content master 512. Further, it is preferable that transcoder 514 reference the same or similar policies that content will encounter at the exhibition theatre 550.

The content, whether ready at step 616 or transcoded, replicated, and/or packaged in step 618 is provided to a D-Cinema system comprising screen server 516 and projector 518. The content is loaded onto the screen server 516 in step 620. Quality is checked in step 622 by initiating playout and monitoring the playout to ensure that no property of content master 512 produces unacceptable artifacts after being processed by transcoder 514. If judged in step 624 to be unacceptable, the issue is reported in step 626, otherwise the content is distributed in step 628, and the process concludes at 630, generally by billing the client. Note that the report in step 626 may result in an order to ‘ship it anyway’ in which case step 628 is performed, or step 626 may result in a rework of some or all of content master 512 which may require repeating quality control check 610 on some or all of content master 512 at a later time. According to other implementations, those of skill in the art will recognize that the transcoding 618 can be performed either before or after the transfer to the screen server, but generally must be performed prior to the initiate and monitor playout 622.

If content master 512 includes any encrypted portions, transcoder 514 and screen server 516 must be provided with the appropriate decryption keys.

In the case of physical distribution, duplicator 522 is used to make multiple copies of content. Duplicator 522 may comprise a hard disk copying station, a DVD burner, a DVD press, or other digital media reproduction device. For small volumes, even a personal computer can be used to copy data to hard drives, for instance an external USB drive, or for burning CDs or DVDs. Physical media 530, such as external or removable hard disk 532 or DVD 534 are shipped, preferably in a protective container (not shown) to exhibition theatre 550 where the physical media 530 is provided to ingest server 552.

For distribution using telecommunications 540, the content master 512 is read to a sending interface for transmission across a communications channel to a receiving interface at the exhibition theatre 550. As an example, the sending interface may comprise a transmitter 524 and transmitting antenna 526, the communications channel may comprise satellite 542, and the receiving station comprises receiving antenna 544 and receiver 546 connected to ingest server 552. In an alternative implementation, the stations and communication channel can comprise a network connection traversing the Internet, preferably using Virtual Private Network (VPN) or other well known techniques to ensure privacy and security. Other implementations using the telephone network, other wireless data transmission channels, or combinations of all the foregoing may be used.

Ingest, transcode, and playout process 650 begins at step 652, awaiting the arrival of content 530 via one or more delivery channels. Content is received 654 and examined in step 656 to determine whether transcoding is needed, as was done in step 616. If the determination is made that transcoding is needed, ingest server 522 initiates transcode, replication, and/or packaging 658, as would have been tested in step 618.

Preferably the transcode 658 is performed by software on ingest server 552, with or without hardware acceleration (e.g., a special transcoder chip or card, not shown). Alternatively, ingest server 552 can access a local transcoder box (not shown). In still another implementation, ingest server 552 can provide the content to screen server 562 and have the transcoding 658 performed there. This latter implementation has the advantage that, late at night, after all the shows have completed, a twenty-plex cinema house may have a considerable amount of computing power idle. Thus, the transcoding (if required) can be performed either prior to or after delivery to the screen server.

Regardless of the location of processing 658 (if it was even required in step 656), the now D-Cinema compliant content is placed in storage 520, preferably a disk 554 accessible to ingest server 552 (which may be distribution disk 532 if there is sufficient room). Alternatively, the D-Cinema compliant content may be placed directly on screen server 562, or if transcode 658 takes place at screen server 562, the resulting files may simply be stored locally and remain there.

After the D-Cinema compliant content has been stored, it is transferred as needed to the screen server 562 for auditorium 560 in step 662. While this process is preferably an automatic transfer, it may be initiated manually, or if there is no network connection from ingest server 552 to screen server 562, step 662 may included the physical transport of hard disk 554 or 532 to the screen server 562 to be mounted and read directly.

The playout of the transcoded, replicated, and packaged content may be scheduled in step 664, preferably in conjunction with other content 150 which preferably includes a feature 156. This schedule can be based on a predetermined time set by the exhibition theater.

The scheduling of an SPL to playout on screen server 562 triggers or schedules a trigger of step 668, wherein the CPLs and SPLs discussed in conjunction with FIGS. 2 and 3 are created or updated. This process is described below. The creation of CPLs corresponding to the SPL is preferably performed by the ingest server 552 and the resulting CPLs are provided to the screen server 562, which requires no special ability of the screen server 562 other than to accept and play as scheduled standard SPL referencing standard CPLs referencing standard track files (and standard subpicture files, if used).

In an alternative implementation, the CPLs described in conjunction with FIGS. 2 and 3 can be created as part of content master 512 by prior art processes and transcode steps 618 and 658 produce the appropriate identifications in the resulting track files so that the resulting transcoded, replicated and packaged content is the content referenced by those CPLs.

Playout of the SPL occurs and concludes in step 670 as the screen server 562 executes the SPL and the presentation is given on projector 564. Note that mastering 510 and auditorium (exhibition theater) 560 both have audio equipment (not shown, but well known) attached to their corresponding screen servers 516 and 562 for respectively evaluating and presenting the audio portion of the program.

The delivery of non D-cinema content to an exhibitor (e.g., a theater) is cheaper and faster than delivering D-cinema content or D-cinema compliant content. By using non D-cinema content, significantly higher compression rates can be achieved with MPEG encoding (i.e., DVD standard), than with JPEG 2000 encoding (i.e., the D-cinema standard). As will be apparent, the smaller data size makes the content transfer take less time. Thus, when distributing the content via satellite, the size reduction afforded by the present principles will reduce distribution cost by a like factor. For example, this reduction could be 25:1 or more depending on the actual content.

In an alternative implementation, the loading or execution of the SPL itself may induce modifications to the SPL or the referenced CPLs. This preferably includes redacting as-yet-unplayed portions of the presentation or repeating previously played portions of the presentation as needed to extend or shorten the duration of the presentation. Such shortening or lengthening of the presentation may be in response to external signals representing, for example, one or more of long lines at the concession stand, weather conditions affecting audience arrival times, or a medical or janitorial emergency in a particular auditorium (e.g., the policies and procedures of the particular auditorium/exhibition theater). The shortening or lengthening could also be based on meeting a predetermined time schedule of the exhibition theater.

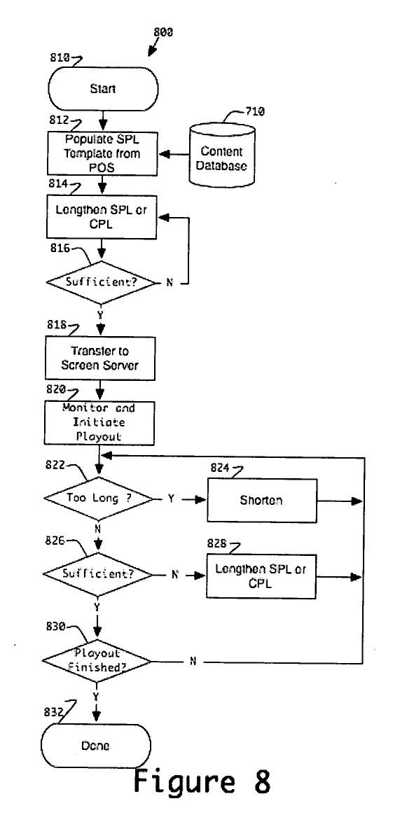

Such a process is shown in FIG. 8, where such signals are detected and acted upon in steps 822 and 826.

A simple algorithm for a shortening process is to omit from the playlist the next piece of content that is not currently playing.

A simple algorithm for a lengthening process is to first restore in reverse order, each piece of content that has been omitted, inserting each piece of restored content as the next piece of content to play. When no further omitted content is available to restore, additional content may be selected by any procedure (including random selection), and inserted as the next piece of content to play.

If playout is paused, the simple shortening algorithm can be perfectly reversed by the simple lengthening process and vice versa. In this special case, the two algorithms are commutative. This is not the case if playout is proceeding and the two algorithms take effect during distinct pieces of content. It is not required that the shortening and lengthening processes are commutative: many acceptable algorithms for shortening will not be ‘undone’ by a companion algorithm for lengthening, unless specific care is taken to design reversibility into the two processes. Generally, it is not a requirement.

The simple shortening and lengthening algorithms above are generally too simple. Ideally, heuristics or rules are employed to improve the likely value (aesthetic or monetary) of the resulting presentation. In order to permit this achievement, more information is needed regarding the content being or potentially being presented.

A example content database 710 provides information about each piece of content that might be automatically added to or deleted from a timeline, such as by timeline editing process 800.

Timeline 300, as an example, results from performing timeline editing process 800 upon timeline 200 with a requirement for a shorter presentation. Timeline 200 may result from editing process 800 acting on timeline 300 with a requirement for a longer presentation.

Content database 710 provides information about each piece of content that can be used to automatically select one or more pieces of content to be omitted or added. The formats shown in 710 are ideal, but those skilled in the art will recognize many alternatives can also be applied without departing from the scope of the present principles.

A collection of removal rules 720 (only some shown) and addition rules 730 (only some shown) are provided for use in shortening step 824 and lengthening steps 814 and 828.

Further, while the following discussion of shortening step 824 and lengthening steps 814 and 828 reference modifications to the timeline and SPL, the SPL includes references to ad-hoc CPLs such as example CPLs 214, 218, 244, 248, 264, 268, 314, 318, 344, 348, 364, and 368. It is to be understood in the following discussion that modifications to the timeline or SPL may include implicit addition of, deletion of, or modification to such ad-hoc CPLs, depending upon the operation.

Content database 710 ideally provides information for each piece of content, such as:
ContentID is for identifying the specific piece of content with which the information is associated;
ContentType, such as moving image-only content 110, sound-only content 120, still images 130, or image with synchronized sound 140;
ContentName, while usually not needed for algorithms to work, is useful to humans when for displaying SPL contents to projectionists and managers, or for reporting;
ContentDuration, is a measure of the expected playout duration of the associated content which is convenient when determining, for instance, whether music_1 124 is sufficiently long as to accompany both animation 112′ and video_1 114′, or whether one of the two moving images 112′ and 114′ will get bumped (as occurred in the shortening from timeline 200 to timeline 300);
ContentKindType, is a categorization of content where categories commonly seen in theatres today include ads, trivia questions and answers, information about upcoming features, news about celebrities, etc;
ContentVersionDate, is used to determine which of two versions of data associated with a piece of content is more recent;
ContentActivationDate is used to disallow the use of a piece of content before a specific date, such as a product launch or feature release, or holiday themed content;
ContentSunsetDate is similarly used to disallow the use of content after a specific date;
ContentRatingType is not a rating of the content itself, but rather identifies content is appropriate to accompany feature presentations up to a certain rating;
ContentLanguage identifies the primary language in which the content is presented and will generally be selected to match the primary language of the feature presentation;
GroupID, when common to two or more pieces of content, identifies that members of the group should be inserted or removed together, as a group, though not necessarily as consecutive entries (an example would be a trivia question and a trivia answer which may allow up to 30 seconds of unrelated intervening content);
GroupSequence, if non-null, specifies the order in which the members of the group should appear (i.e., the trivia question GroupSequence=1, while the trivia answer GroupSequence=2);
GroupSeparation determines for each piece of content the maximum amount of time that may lapse between its finish and the start of the next member of the group (i.e., from the above example, the trivia question GroupSeparation=00:00:30:000, but if the value were 00:00:00:000, then the trivia answer would need to follow consecutively);
GroupDuration, if non-null, specifies the duration contributed by a group so that the aggregated ContentDuration of a group is convenient;
ContentRegionType allows content to be selected by market, preferably in a hierarchical arrangement, so that, for instance ads for the Los Angeles market are not included in New York, but ads for the California market may be used in Los Angeles;
ContentSupplierID is preferably provided to determine the path by which the content was supplied, as frequently this is useful to diagnosing problems and also for allocating advertising revenue share;
ContentOwnerID is preferably provided to determine the owner of the content, again for diagnosing problems, but also for billing advertising fees;
ContentConractType is preferably used by rules to implement contractual obligations for when, how often, and under what other conditions an piece of content can, shall, or shall not be presented; and,
ContentValue represents a value to the exhibitor such as expected revenue, but may also include other dimensions such as aesthetic value to an audience.

Those skilled in the art will recognize that some, all, or different information about the content might be usefully included in content database 710, and that the fields listed herein are by way of example and not a limitation thereof.

D-Cinema content 150 such as TRAILER 154 and theatre policy content such as INTRO 152 are also included in content database 710 and subject to shortening step 824 and lengthening steps 814 and 828. Also, it is desirably that feature content such as FEATURE 156 are also listed in content database 710, but such content is preferably not subject removal or insertion in steps 814, 824, and 828.

Removal rule base 720 shows a partial collection of rules suitable to shortening step 824. In one embodiment, all rules of a given rank (the first column of 720) may be attempted until the shortening goal is achieved. When the rules of the given rank have been exhausted, the rules of the next rank may be attempted, and so on until the shortening goal is achieved.

In an alternative implementation, some rules of higher ranks may cause rules of lower ranks to regain effectiveness. In this case, if the rules of one rank cease to provide the ability to shorten a show, then the rule at the next higher rank is tried. If successful, further attempts may begin with the rules at lower ranks.

Other rule selection processes can be implemented: For instance, randomly executing rules in a range of ranks; or employing a Monty Carlo algorithm to evaluate the progress toward a goal of candidate random groups or individual rule executions, with the candidate having the greatest progress or the lowest reduction in value being the rule actually executed; or an exhaustive search using a similar candidate evaluation to determine the best rule to apply.

Example removal rule base 720 provides pseudo-database-query-like expressions to describe the algorithm employed by each rule. The rule in rank one searches for content having both a ContentKindType of ‘information’ (e.g., “Recording devices of any kind are prohibited in this facility.”) and a ContentValue less than ‘5’. Since more than one piece of content might meet that criteria, the sort column specifies that results should be sorted in an order so that the minimum ContentValue is removed first. Other sorts include selecting content having the maximum duration first, or just selecting the first content found in the timeline to meet the criteria.

Some rules make use of functions, such as the removal rule base 720 rank 3, which activates (the first clause becomes true) when it is less than three minutes until showtime, in which case content advertising that there is popcorn for sale in the lobby (ContentKindType==concessions) is on the chopping block.

In the case that groups or other special configurations of content are supported, specific algorithms are required, such as ensuring that if any member content of a group is deleted, that all content of that same group is removed.

Such special algorithms include combining image-only content (e.g. animation 112) with audio-only content (e.g., music_1 124) to provide a presentation having simultaneous image and sound. In a timeline, if the image and audio have different durations, the longer of the two must be deleted to shorten the timeline.

When there is a section of the timeline bounded on both sides by either end of the timeline, or content having image with synchronized sound (e.g., synchronous content 140 & 150) then if the intervening content contains overlapping image-only and audio-only content having mutual alignment and durations such that a portion of the audio-only content is unaccompanied, then the image portion of the presentation can be supplied by a rule to select image-only content having a ContentDuration shorter than the gap, or carousel content 210 is the fallback.

If the mismatch results in image-only content having no corresponding audio content, then audio-only content is select until the gap is exactly closed, or moves into the image portion of the timeline. In an alternative embodiment, silence or special purpose audio-only content such as nature sound (e.g., sea shore sounds, or rain forest sounds) may be used in the same manner as the carousel images, that is, a sound track that has no particular beginning or end, nor a required duration . . . it can be played at any time, and repeated as needed.

Similarly, addition rule base 730 supports lengthening steps 814 and 828 by identifying content listed in content database 710 to be added to a timeline. The rules shown in 730 show additional functions that allow the rules to reference other content relative to a candidate placement. For instance, rule base 730 row 1 is applied at the insertion point in the timeline so that the first clause looks for content in content database 710 having ContentKindType that is different from the ContentKindType of the content immediately prior to the insertion point. In this way, lengthening process will not insert two ads in a row, nor two news items in a row. That same rule also ensures that the content selected is not violating a requirement of the previous piece of content to have content with the same GroupID immediately follow.

The rule in row 2 of addition rule base 730 searches for content that matches the GroupID of some piece of content prior to the insertion point, but not strictly limited to an examination of the immediately prior content. If found, the second clause ensures that the content selected for insertion is the next one of the group sequence.

These two examples of insertion presume that the timeline is growing from a specific insertion point and that content following that insertion point does not need to be considered in the lengthening algorithm.

In an alternative implementation, the insertion point might be permitted to occur anywhere within a specific range (e.g., anywhere prior to TRAILER 154). In such a case, insertion rules may also need to look forward. For example, the intent of rule 1 in addition rule base 730 is to attempt to select content having the highest ContentValue that does result in two consecutive pieces of content having the same ContentKindType. In order to achieve this in the alternative embodiment, the first clause might be replaced by the clause NOT(ContentKindType==Previous: ContentKindType OR ContentKindType==Next: ContentKindType), where Next: is a function that examines a property of the next piece of content following the insertion point.

When evaluating the insertion or deletion of audio-only content, rules may include comparisons strictly against other content having like ContentType (i.e., rules for selecting audio-only may consider only other audio-only content).

Other rules evaluating insertion or deletion of audio-only content may consider evaluating content of the opposite kind: for instance, the clause NOT(ContentKindType==ad && Overlap:ContentKindType==ad) would prevent selection of content such that two ads, one audio and one image, would overlap. Such rules allow the construction of presentations that allow audio ads to effectively sponsor trivia and news content, while image-only ads can sponsor music, interviews, commentary, nature sounds, and other non-advertising audio.

Timeline editing process 800 is initiated with step 810. If a prior timeline is not being edited, an SPL template is preferably provided in step 812. A template is an ideal method for implementing the policies of exhibition theatre 550 and ensuring that any essential content is included, for example INTRO 152. Also in step 812, the exhibitor's point-of-sale (POS) system (not shown) is queried and the CPL for feature 156 for which this SPL is being created is added. Any automation cues or commands pertinent to INTRO 152 (such as a curtain call, closing the doors, and dimming the auditorium lights), FEATURE 156 (such as bringing the lights up during the credits) are also preferably included in the template. Content database 710 is ideally queried for the properties of FEATURE 156, for example to acquire the ContentRatingType for FEATURE 156. Alternatively, the CPL of FEATURE 156 can be examined.

The template includes one or more default durations of carousel 210 to cause the timeline to begin at an approximation of the desired duration.

In lengthening step 814, the process of building a satisfying presentation is performed, using rules such as in addition rule base 730. Lengthening step 814 considers that some portions of the SPL designated as carousel 210 (for example, that portion of the timeline less than fifteen minutes prior to first trailer TRAILER 154) empty for the purpose of inserting video-only content. Such an algorithm ensures that for the fifteen minutes before TRAILER 154, every rule in addition rule base 730 will have been tried to find image-only content that can be placed in lieu of carousel 210. However, if no fit can be made, the carousel 210 is the only remaining choice.

If after each insertion into the timeline, step 816 determines whether the timeline is sufficiently long. This determination can consider other criteria, such as “is the 15 minutes prior to the first trailer composed of less than 10% carrousel content”. If the SPL is found lacking, then timeline editing process 800 repeats lengthening step 814. Otherwise, the SPL, CPLs, and the corresponding content files are transferred to screen server 562 in step 818 and is scheduled to play, preferably in accord with the information from the exhibitor POS (not shown).

Alternatively, the candidate content can be transferred to screen server 562 earlier and all or part of steps 810, 812, 814, and 816 can take place on screen server 562.

Shortly before playout begins and preferably even during playout, external events are monitored and the timeline, SPL and CPLs are updated to bring the properties of the timeline into conformance with goals. The most common goal is that FEATURE 156 start at a time other than originally scheduled by the POS (not shown), for example when heavy snow is delaying audience arrival in exhibition theatre 550 (in industry parlance, a ‘snow hold’). Other goals may include recognizing that more current versions of content have been delivered (for instance a newer ContentVersionDate is in content database 710) or that some content has expired (using ContentSunsetDate from database 710). In the remainder of this example of the timeline editing process 800, the goal of dynamically adjusting the length of the timeline is considered.

In step 822, an evaluation is made whether the current SPL results in the FEATURE 156 starting later than is currently desired. If so, the shortening step 824 is performed, by, for example, screen server 562. Such an event might occur if a snow hold had been put in place and the scheduled time had been delayed, but now the weather is lighter or the delay has been sufficient, and the timeline should be adjusted to provide a best possible start time for FEATURE 156.

If the timeline is not too long, it is tested as to whether it is sufficiently long (Step 826), for example, if a snow hold has recently been put into place but the INTRO 152 hasn't yet announced the start of the feature. In this case, an attempt is made to lengthen the timeline by performing step 828.

So long as the timeline could plausibly change, the monitoring process loops at step 830. There is no need for the monitoring process to run more often than once per piece of content played. Thus, for computational economy, the looping at step 830 may wait until shortly before the end of each piece of content before determining whether the playlist requires modification. This of course can be advanced, as needed to afford adequate time for the computation. Further, step 830 may be implemented to ignore individual images within carousel 210, or in the alternative, the examination may take place for each iteration of the slides file 212 or individual slides (e.g., 132′ or 132″).

When there is no further plausible modification to the timeline, editing process 800 ends at step 832.

The methods may be implemented by instructions being performed by a processor, and such instructions may be stored on a processor-readable medium such as, for example, an integrated circuit, a software carrier or other storage device such as, for example, a hard disk, a compact diskette, a random access memory (“RAM”), or a read-only memory (“ROM”). The instructions may form an application program tangibly embodied on a processor-readable medium. As should be clear, a processor may include a processor-readable medium having, for example, instructions for carrying out a process.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are within the scope of the following claims.

1. A method for providing non D-cinema content for distribution and playback at theaters, the method comprising the steps of:
performing a quality control check on content master comprising non D-cinema content, the quality control check including:
transcoding the non D-cinema content to produce D-cinema compliant content;
transferring the D-cinema compliant content into a screen server;
initiating playout and monitoring to ensure no unacceptable artifacts are present after transcoding;
determining acceptability of the coded D-cinema compliant content; and
duplicate/distribute the content master to a theater to be displayed when it has been determined to be acceptable.

2. The method of claim 1, wherein said transcoding is performed according to policies to be encountered at an exhibition or displaying theater.

3. The method of claim 1, further comprising checking the content master to determine if at least a portion of the content master is coding ready.

4. The method of claim 1, wherein said transcoding is substantially the same transcode used by an exhibition facility.

5. The method of claim 1, wherein said transcoding is identical to a transcode used by an exhibition facility.

6. The method of claim 1, wherein the non D-cinema content comprises MPEG encoded content.

7. The method of claim 1, wherein the transcoding is performed prior to transferring to the screen server.

8. The method of claim 1, wherein the transcoding is performed after the transferring to the screen server.

9. A method for playing back non D-cinema content at an exhibition theater comprising the steps of:
receiving a content master comprising the non D-cinema content at the exhibition theater;
transcoding the non D-cinema content into a D-cinema compliant content form;
transferring the content to a screen server;
scheduling the playout of the D-cinema compliant content along with other content; and
executing the playout schedule which includes both the D-cinema compliant content, and the other content.

10. The method of claim 9, wherein said scheduling comprises forming a show play list (SPL) having one or more composition playlist (CPL).

11. The method of claim 10, wherein said forming further comprises modifying the SPL or internal one or more CPL to extend or shorten the SPL to accommodate preferences of the exhibition theater.

12. The method of claim 9, further comprising:
storing the received non D-cinema and/or the D-cinema compliant content; and
transcoding the non D-cinema content prior to said executing.

13. The method of claim 9, wherein the non D-cinema content comprises MPEG encoded content.

14. The method of claim 10, wherein said modifying comprises:
populating an SPL template from a point of sale (POS) system;
lengthening the SPL or an internal CPL using rules in a rules database maintained by the exhibition theater;
transferring the modified SPL to a screen server when the length of the SPL has been determined to be sufficient.

15. The method of claim 14, further comprising:
monitor and initiate playout of the SPL;
determining, during playout, if the SPL is too long;
shortening the SPL when it is determined to be too long.
determining if the SPL length is sufficient when it is not too long; and
lengthening the SPL when it is determined the length is not sufficient.

16. The method of claim 9, wherein the transcoding is performed prior to the transferring.

17. The method of claim 9, wherein the transcoding is performed after the transferring.

18. A computer program product comprising a computer usable medium having computer readable program code embodied thereon for use in communicating data over a communication channel, the computer program product comprising:
program code for receiving the non D-cinema content at the exhibition theater;
program code for transcoding the non D-cinema content into a D-cinema compliant content form;
program code for transferring the content to a screen server;
program code for scheduling the playout of the D-cinema compliant content along with other content; and
program code executing the playout schedule which includes both the D-cinema compliant content, and the other content.

19. The computer program product of claim 18, further comprising program code for forming a show play list (SPL) having one or more composition playlist (CPL).

20. The computer program product of claim 19, wherein said program code for forming further comprises program code for modifying the SPL or internal one or more CPL to extend or shorten the SPL to accommodate preferences of the exhibition theater.

21. The computer program product of claim 18, further comprising:
program code for storing the received non D-cinema and/or the D-cinema compliant content; and
program code for transcoding the non D-cinema content prior to said executing.

22. The computer program product of claim 20, wherein said program code for modifying further comprises:
program code for populating an SPL template from a point of sale (POS) system;
program code for lengthening the SPL or an internal CPL using rules in a rules database maintained by the exhibition theater; and
program code for transferring the modified SPL to a screen server when the length of the SPL has been determined to be sufficient.

23. The computer program product of claim 22, further comprising:
program code for monitoring and initiating playout of the SPL;
program code for determining during playout, if the SPL is too long;
program code for shortening the SPL when it is determined to be too long.
program code for determining if the SPL length is sufficient when it is not too long; and
program code for lengthening the SPL when it is determined the length is not sufficient.

24. The computer program product of claim 18, wherein the program code for transcoding is configured to perform the transcoding before the program code for transferring transfers the content to the screen server.

25. The computer program product of claim 18, wherein the program code for transcoding is configured to perform the transcoding after the program code for transferring transfers the content to the screen server.

26. An apparatus for playing back non D-cinema content at an exhibition theater comprising:
a receiver for receiving the non D-cinema content;
a processor configured to transcode the non D-cinema content into D-cinema compliant content;
a screen server configured to receive the D-cinema compliant content and deliver the same to a projector.

27. The apparatus of claim 26, wherein the transcoded D-cinema compliant content delivered to the projector is substantially similar to post-transcoded D-cinema content previously reviewed at a distribution side of the content.

28. The apparatus of claim 26, wherein the screen server is further configured to schedule the playout of the D-cinema compliant content along with other content, and to execute a playout schedule including both the D-cinema compliant content and the other content.

29. The apparatus of claim 28, wherein the playout schedule comprises a show play list (SPL) having one or more composition play list (CPL).

30. The apparatus of claim 29, wherein the processor and screen server cooperate to modify the SPL or the one or more CPL to extend or shorten the SPL to accommodate preferences of an exhibition theater.

31. The apparatus of claim 30, wherein the preferences of the exhibition theater are maintained in a rule database stored in a storage medium that is in communication with the processor.

32. The apparatus of claim 28, wherein the playout schedule comprises a show play list (SPL) having one or more composition play list (CPL), the show play list being executed at a predetermined time in an exhibition theater.

33. The apparatus of claim 32, wherein the processor and screen server cooperate to modify the SPL or the one or more CPL to extend or shorten the SPL to accommodate the predetermined time at the exhibition theater.

34. An apparatus for playing back non D-cinema content at an exhibition theater comprising:
a receiver for receiving the non D-cinema content;
a screen server configured to receive the non D-cinema content; and
a processor configured to transcode the non D-cinema content into D-cinema compliant content after being received by the screen server;
wherein the screen server delivers the D-cinema compliant content to a projector.

35. The apparatus of claim 34, wherein the transcoded D-cinema compliant content delivered to the projector is substantially similar to post-transcoded D-cinema content previously reviewed at a distribution side of the content.

36. The apparatus of claim 34, wherein the screen server is further configured to schedule the playout of the D-cinema compliant content along with other content, and to execute a playout schedule including both the D-cinema compliant content and the other content.

37. The apparatus of claim 36, wherein the playout schedule comprises a show play list (SPL) having one or more composition play list (CPL).

38. The apparatus of claim 37, wherein the processor and screen server cooperate to modify the SPL or the one or more CPL to extend or shorten the SPL to accommodate preferences of an exhibition theater.

39. The apparatus of claim 38, wherein the preferences of the exhibition theater are maintained in a rule database stored in a storage medium that is in communication with the processor.

40. The apparatus of claim 36, wherein the playout schedule comprises a show play list (SPL) having one or more composition play list (CPL), the show play list being executed at a predetermined time in an exhibition theater.

41. The apparatus of claim 40, wherein the processor and screen server cooperate to modify the SPL or the one or more CPL to extend or shorten the SPL to accommodate the predetermined time at the exhibition theater.
